(19) United States
(12) Patent Application Publication
(10) Pub. No.: US 2022/0373250 A1
(43) Pub. Date: Nov. 24, 2022

(54) Refrigerator Supporting Rod for Installing Lighting Device

(71) Applicants: Wanjiong Lin, Ningbo (CN); Self Electronics Co., Ltd., Ningbo (CN); Self Electronics USA Corporation, Norcross, GA (US)

(72) Inventors: Feng Ji, NINGBO (CN); Zhaoyong Zheng, NINGBO (CN)

(21) Appl. No.: 17/664,529

(22) Filed: May 23, 2022

(30) Foreign Application Priority Data
May 24, 2021 (CN) 202110568014.3

(51) Int. Cl. F25D 27/00

(52) U.S. Cl. CPC F25D 27/00; F25D 2201/12; F25D 2400/02

(57) ABSTRACT

A refrigerator supporting rod for installing lighting device has a rod body, the rod body having an inner side surface facing toward the refrigerator and an outer side surface back toward the refrigerator, a heat insulating layer is provided between the inner side surface and the outer side surface, the inner side surface is provided with a lamp mounting groove extending in the longitudinal direction. According to the refrigerator supporting rod for installing lighting device, a lamp can be installed in an embedded mode to integrate the two, so that the probability of touching the lamp is reduced, and the likelihood of damage is reduced.

### RELATED APPLICATION

This application claims priority to Chinese Patent Application No. CN 202110568014.3, filed on May 24, 2021, the entire specification of which is incorporated herein by reference.

### FIELD OF THE TECHNOLOGY

The present invention relates to a freezer and refrigerator illumination, particularly a refrigerator supporting rod for installing lighting device.

### BACKGROUND

The freezer needs the refrigerator supporting rod to build a frame, wherein the freezer for exhibition is with at least one side of the refrigerator that is transparent, and the general mode is to support the finger frame through the cold cabinet and then install the transparent plate to obtain a transparent door panel, for the product better displaying, a lighting device will be installed in the inner side of the partial cold cabinet support rod to illuminate the project.

At present, the lamp of freezer lighting is usually mounted on the inner surface of the refrigerator supporting rod, which requires the user to bear the manual expenditure, and the lamp will be higher than the rod assembly, which is prone to collision during use, and the lamp is damaged.

### BRIEF SUMMARY OF THE INVENTION

In view of this, the present invention provides a refrigerator supporting rod for installing lighting device to solve the above technical problems.

A refrigerator supporting rod for installing lighting device includes a rod body, and the rod body includes a inner side surface facing toward the refrigerator and a outer side surface back toward the refrigerator, a heat insulating layer is provided between the inner side surface and the outer side surface, the inner side surface is provided with a lamp mounting groove extending in the longitudinal direction.

Both sides of the top surface of the lamp mounting groove are reflective surfaces.

The reflective surface is white.

The rod body is manufactured by extrusion, and the reflective surface is manufactured by two-color extrusion.

The lamp mounting groove is provided with at least two intervals distributed lamp buckles.

The outer side surface is provided with a heating module extending in the longitudinal direction.

The heating module comprises a thermal wire paved in the longitudinal direction and a heat conductive plate connected to the outer side surface.

The heat conductive plate is a U profile, and ends of the two sides of the U profile is bent inward, and the outer side surface is provided with two strip groove supporting both sides of the U profile.

The rod body is a hollow structure, the heat insulating layer is made of heat insulating material filled in the hollow structure.

The insulating material is polyurethane.

The technical effects of the present invention:

The present invention is used to mount the refrigerator supporting rod for mounting the lighting device, which can be embedded in the lamp, so that the two are integrated, reducing the charging time of the lamp, reducing damage, and a reflective surface is provided in the cold cabinet support rod, which can better utilize the stray light of the lamp, improve efficiency and the lighting effect, and improve anti-glare effects.

### BRIEF DESCRIPTION OF THE DRAWINGS

Embodiments of the present invention will be described below with reference to the drawings, in which:

FIG. 1 is a structural diagram of the refrigerator support rod (without the lamp) for mounting the lighting device of the present embodiment.

FIG. 2 is a structural diagram of the refrigerator support rod (with lamp) for mounting the lighting device of the present embodiment.

FIG. 3 is an explosion diagram of the refrigerator support rod (with lamp) for mounting the lighting device of the present embodiment.

FIG. 4 is a cross-sectional view of the refrigerator support rod (with lamp) for mounting the lighting device of the present embodiment.

### DETAILED DESCRIPTION OF THE INVENTION

Specific embodiments of the present invention will be described in further detail below based on the drawings. It should be understood that the description of the embodiments of the present invention herein is not intended to limit the protection scope of the present invention.

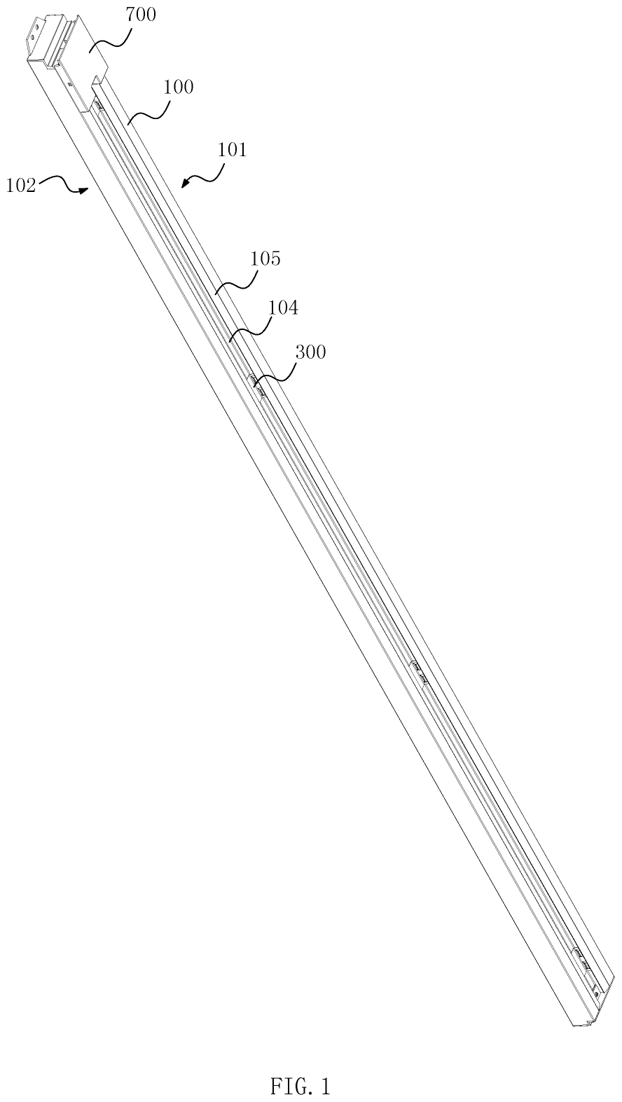

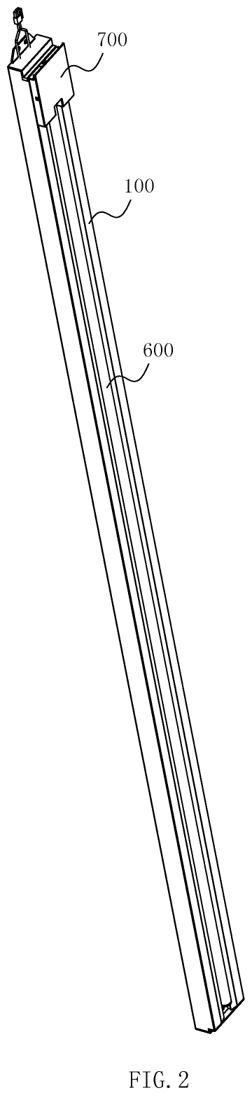

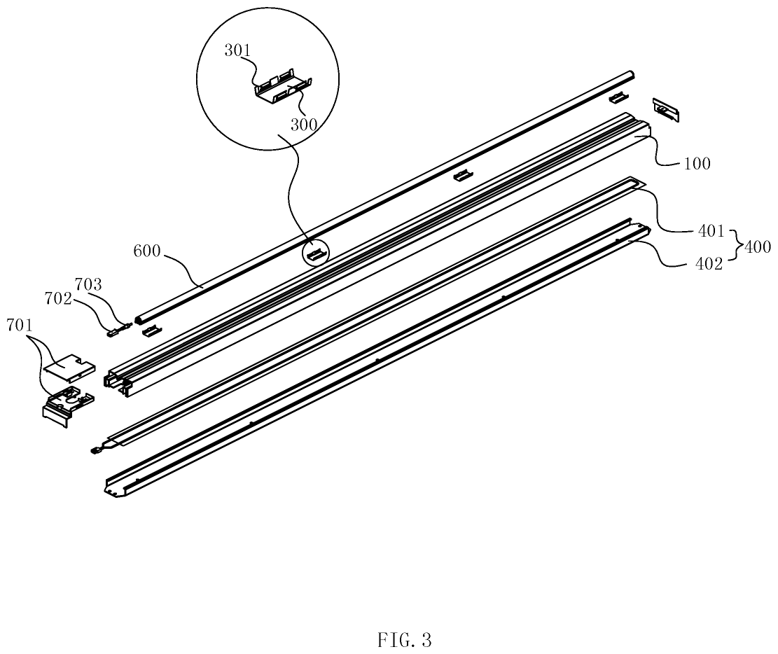

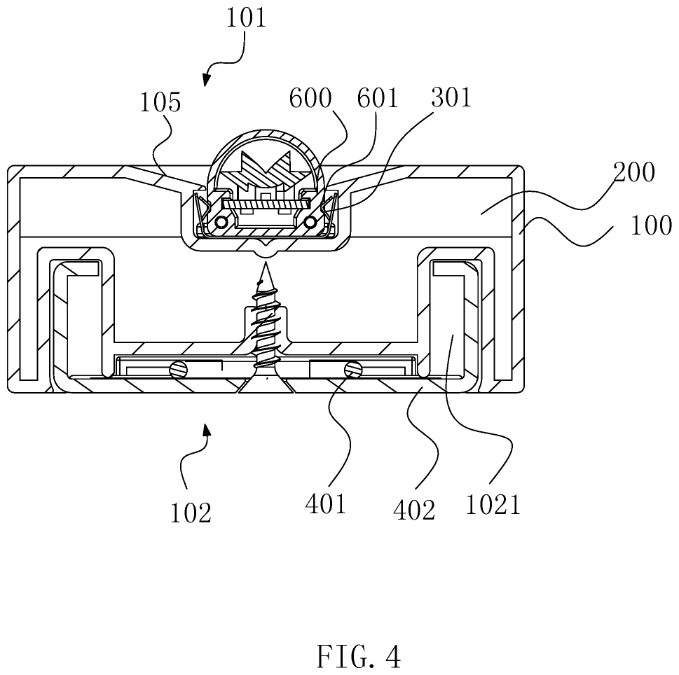

As shown in FIGS. 1-4, the refrigerator supporting rod for installing lighting device includes a rod body 100, and the rod body 100 includes an inner side surface 101 facing toward the refrigerator and an outer side surface 102 back toward the refrigerator, a heat insulating layer 200 is provided between the inner side surface 101 and the outer side surface 102, and the inner side surface 101 is provided with a lamp mounting groove 104 extending in the longitudinal direction.

When the refrigerator is mounted, the inner side surface 101 of the refrigerator support rod in the present embodiment faces the inside of the refrigerator, and the outer side surface 102 towards the outside of the refrigerator, and the refrigerator supporting rod can be vertically disposed, or be arranged laterally, the inner side surface 101 of the refrigerator supporting rod in the present embodiment is equipped with a lamp.

The lamp mounting groove 104 can be used for recessed installation of a lamp for refrigerator illumination, reducing the touch of the lamp, reducing damage.

In order to facilitate the connection of the external power source, one end of the rod body 100 is provided with a wiring module 700, including an end cap 701, an external plug 702 disposed in the end cap 701 and a plug 703 connected with the external plug 702 and being in electrical connection with the lamp.

In order to improve the efficiency, the effect of preventing glare, in this embodiment, both sides of the top surface of the lamp mounting groove 104 is an reflective surface 105 which is outer expansion. Outer expansion means that the diameter is gradually increased, and can be a flat surface or a curved surface. In this embodiment, the reflective surface 105 is a straight inclined surface. Further, the reflective surface 105 is white. In this embodiment, the rod body 100 generally uses a plastic having certain strength, manufactured by extrusion, so the reflective surface 105 is a better choice for white plastic, facilitating material and manufacturing. Further, the rod body 100 is manufactured by extrusion, and the reflective surface 105 is manufactured by two-color extrusion. The arrangement of the reflective surface 105 can not only utilize the pneumatic light of the lamp, but also improve the light efficiency and the lighting effect, and the applicable lamps of the present invention are large angular light, which has the effect of sweeping. It will produce glare in a wide range, and the setting of the reflective surface 105 can reduce glare. Further, the reflector surface 105 is set symmetrically. The included angle between the reflector surface 105 and the depth direction of the lamp mounting groove 104 is 75°, but can be selected in the range of 60° to 85°.

In order to facilitate mounting and disassembly, in this embodiment, the lamp mounting groove 104 is provided with at least two intervals distributed lamp buckle 300. The lamp buckle 300 is a curved U-shaped spring, and the lower edge of the reflective surface 105 extends to form a card edge, and both sides of the lamp buckle 300 abuts the card edge to achieve a fixation, and both sides of the U-shaped spring are provided with an clamping part 301 which is projecting outward cooperate with the card slot 601 of the lamp 600 to achieve fixing.

This embodiment is used to fit with the opening and closing refrigerator door, the outer side surface 102 is provided with a heating module 400 extending in the longitudinal direction. The outer side surface 102 is fitted with the gate, and the heating module 400 operates to prevent water mist on the door. Further, the heating module 400 includes a thermal wire 401 that is laid in the longitudinal direction and a heat conductive plate 402 connected to the outer side surface 102. The heat conductive plate 402 uses a ferroelectric material and can play the role of support. In order to increase the intensity of the heat conductive plate 402, the heat conductive plate 402 is a U-profile, and the end of the two sides of the U-profile is bent inward, and the outer side surface 102 is provided with two strip grooves 1021 supporting two sides of the U-profile.

In order to increase the heat insulating effect, the rod body 100 is a hollow structure, and the heat insulating layer 200 is made of heat insulating material filled in the hollow structure. Further preferred, the heat insulating material is polyurethane, the price is inexpensive, and the material is easy to obtain. With the arrangement of the strip groove 1021 and the lamp mounting groove 104, the rod body 100 has a lot of concave structures, so that the internal volume is small, thereby reducing the use of the heat insulating material, reducing manufacturing cost.

The above are only preferred embodiments of the present invention, and are not used to limit the protection scope of the present invention. Any modification, equivalent replacement or improvement within the spirit of the present invention is covered by the scope of the claims of the present invention.

What is claimed is:

1. A refrigerator supporting rod for installing lighting device, comprising a rod body (100), the rod body (100) comprises a inner side surface (101) facing toward the refrigerator and a outer side surface back toward the refrigerator, a heat insulating layer (200) is provided between the inner side surface (101) and the outer side surface (102), characterized in that, the inner side surface (101) is provided with a lamp mounting groove (104) extending in the longitudinal direction.

2. A refrigerator supporting rod for installing lighting device as claimed in claim 1, wherein both sides of the top surface of the lamp mounting groove (104) are reflective surfaces (105).

3. A refrigerator supporting rod for installing lighting device as claimed in claim 2, wherein the reflective surface (105) is white.

4. A refrigerator supporting rod for installing lighting device as claimed in claim 3, wherein the rod body (100) is manufactured by extrusion, and the reflective surface (105) is manufactured by two-color extrusion.

5. A refrigerator supporting rod for installing lighting device as claimed in claim 1, wherein the lamp mounting groove (104) is provided with at least two intervals distributed lamp buckles (300).

6. A refrigerator supporting rod for installing lighting device as claimed in claim 1, wherein the outer side surface (102) is provided with a heating module (400) extending in the longitudinal direction.

7. A refrigerator supporting rod for installing lighting device as claimed in claim 6, wherein the heating module (400) comprises a thermal wire (401) paved in the longitudinal direction and a heat conductive plate (402) connected to the outer side surface (102).

8. A refrigerator supporting rod for installing lighting device as claimed in claim 7, wherein the heat conductive plate (402) is a U profile, and ends of the two sides of the U profile is bent inward, and the outer side surface (102) is provided with two strip groove (1021) supporting both sides of the U profile.

9. A refrigerator supporting rod for installing lighting device as claimed in claim 1, wherein the rod body (100) is a hollow structure, the heat insulating layer (200) is made of heat insulating material filled in the hollow structure.

10. A refrigerator supporting rod for installing lighting device as claimed in claim 9, wherein the insulating material is polyurethane.
